(19) United States
(12) Patent Application Publication
(10) Pub. No.: US 2007/0141450 A1
(43) Pub. Date: Jun. 21, 2007

(54) Rechargeable fuel cell with double cathode

(75) Inventors: Hai Yang, Shanghai (CN); Qunjian Huang, Shanghai (CN); Chang Wei, Niskayuna, NY (US); Jun Cai, Shanghai City (CN); Jinghua Liu, Shanghai (CN); Shengxian Wang, Shanghai (CN); Qijia Fu, Shanghai (CN)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/313,634

(22) Filed: Dec. 21, 2005

(51) Int. Cl. H01M 2/36; H01M 2/08; H01M 8/10; H01M 8/24

(52) U.S. Cl. 429/72; 429/185; 429/38; 429/32

(57) ABSTRACT

A fuel cell assembly may be provided that includes a first cathodic electrode and a second cathodic electrode; an anodic electrode positioned between the first cathodic electrode and the second cathodic electrode; a first membrane positioned between the first cathodic electrode and the anodic electrode; a second membrane positioned between the second cathodic electrode and the anodic electrode; and a seal ring for sealing the fuel cell assembly, the seal ring comprising a water-refilling mechanism.

### FIELD

Embodiments may relate to a rechargeable fuel cell cathode. Embodiments may relate to a method for making and for using the rechargeable fuel cell cathode.

### BACKGROUND

A fuel cell may convert the chemical energy of a fuel directly into electricity without any intermediate thermal or mechanical processes. Energy may be released when a fuel reacts chemically with oxygen in the air. A fuel cell may convert hydrogen and oxygen into water. The conversion reaction occurs electrochemically and the energy may be released as a combination of electrical energy and heat. The electrical energy can do useful work directly, while the heat may be dispersed.

Fuel cell vehicles may operate on hydrogen stored onboard the vehicles, and may produce little or no conventional undesirable by-products. Neither conventional pollutants nor green house gases may be emitted. The byproducts may include water and heat. Systems that rely on a reformer on board to convert a liquid fuel to hydrogen produce small amounts of emissions, depending on the choice of fuel. Fuel cells may not require recharging, as an empty fuel canister could be replaced with a new, full fuel canister.

Metal/air batteries may be compact and relatively inexpensive. Metal/air cells include a cathode that uses oxygen as an oxidant and a solid fuel anode. The metal/air cells differ from fuel cells in that the anode may be consumed during operation. Metal/air batteries may be anode-limited cells having a high energy density. Metal/air batteries have been used in hearing aids and in marine applications, for example.

It may be desirable to have a fuel cell and/or a metal/air battery having differing characteristics or properties than those currently available.

### BRIEF DESCRIPTION

One embodiment of the invention described herein may include an electrochemical cell. The electrochemical cell may include a first cathodic electrode and a second cathodic electrode; an anodic electrode positioned between the first cathodic electrode and the second cathodic electrode; a first membrane positioned between the first cathodic electrode and the anode; a second membrane positioned between the second cathodic electrode and the anode; and a water-refilling mechanism.

Another embodiment may include a method for increasing rechargeable fuel cell power and reliability for a rechargeable fuel cell that may include an anode, a cathode, electrolyte and a membrane. The method may include adding a second cathode so that the anode is positioned between the two cathodes; and adding one or more mechanisms for water filling and water retention.

Another embodiment may include a rechargeable fuel cell. The rechargeable fuel cell may include a first cathodic electrode and a second cathodic electrode; a first anodic electrode positioned adjacent to the first cathodic electrode; and a second anodic electrode positioned adjacent to the second cathodic electrode; a first membrane positioned between the first cathodic electrode and the first anodic electrode; a second membrane positioned between the second cathodic electrode and the second anodic electrode; and a water-refilling mechanism. The rechargeable fuel cell also may include a third electrode positioned proximal to one of the first anodic electrode or second anodic electrode.

One other embodiment may include a method for preventing or reducing water starvation in a fuel cell comprising: filling and re-filling the fuel cell with water from an external source, during operation of the fuel cell. The third electrode can be nickel foam, which can store the electrolyte or water and has the capability to absorb the water or water vapor.

### BRIEF DESCRIPTION OF FIGURES

FIG. 1 illustrates a side view of one embodiment of a rechargeable fuel cell of the invention having an anode positioned between two cathodes and having a water re-filling mechanism.

FIG. 2 illustrates an exploded perspective view of the rechargeable fuel cell of claim 1.

FIG. 3 is a graphical illustration of time versus voltage versus current for a rechargeable fuel cell of the invention having an anode positioned between two cathodes and having a water re-filling mechanism.

FIG. 4 is an exploded perspective view of another rechargeable fuel cell embodiment of the invention having two anodes positioned between two cathodes and a third electrode positioned between two anodes and having a water re-filling mechanism.

FIG. 5 is a cross-sectional view of a rechargeable fuel cell of the invention having two anodes positioned between two cathodes with the third electrode, illustrating the cap for water filling.

FIG. 6 is a graphical view illustrating capacity in mAh versus voltage for a rechargeable fuel cell of the invention having two anodes positioned between two cathodes with a Ni foam third electrode storing electrolytes and having a water re-filling mechanism.

### DETAILED DESCRIPTION

Embodiments may relate to a rechargeable fuel cell cathode. Embodiments may relate to a method for making and for using the rechargeable fuel cell cathode.

As used herein, the term membrane refers to a selective barrier that permits passage of protons generated at the anode through the membrane to the cathode for reduction of oxygen at the cathode to form water and heat.

As used herein, the terms cathode and cathodic electrode refer to a metal electrode that may include a catalyst. At the cathode or cathodic electrode, oxygen from air is reduced by free electrons from the usable electric current, generated at the anode, that combine with protons, also generated by the anode, to form water and heat. The cathode in the fuel cell embodiments described herein, is, for some embodiments, graphite, and carbon-based materials.

Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value.

In the following description of some embodiments of the invention, reference is made to the accompanying drawings, which form a part hereof, and in which are shown, by way of illustration, specific embodiments of the invention, which may be practiced. In the drawings, like numerals describe substantially similar components throughout the several views. These embodiments are described in sufficient detail to enable one of ordinary skill in the art to practice the invention. Other embodiments may be utilized and structural, logical, and electrical changes may be made without departing from the scope of the invention. The following detailed description is not to be taken in a limiting sense, and the scope of the invention is defined only by the appended claims, along with the full scope of equivalents to which such claims are entitled.

An aspect of one embodiment of the disclosed rechargeable fuel cell design may balance energy output with spacial requirements and water management. In such an embodiment, the rechargeable fuel cell may provide an energy output equal to or surpassing an otherwise similar primary battery, at a size comparable to the battery, while managing water formation and water consumption in the rechargeable fuel cell to prevent flooding and water starvation, respectively.

The mass balance of a rechargeable fuel cell is as follows in formulae (1) and (2):
4M+4H₂0+4e⁻⇄4MH+4OH⁻ (1)
4OH⁻⇄2H₂O+O₂+4e⁻ (2)
During charging of the rechargeable fuel cell, the fuel cell consumes water. During discharge, the consumed water may be recovered. To reduce or eliminate water loss due to evaporation from the fuel cell, the fuel cell may be refilled with water via the disclosed water recharging mechanism.

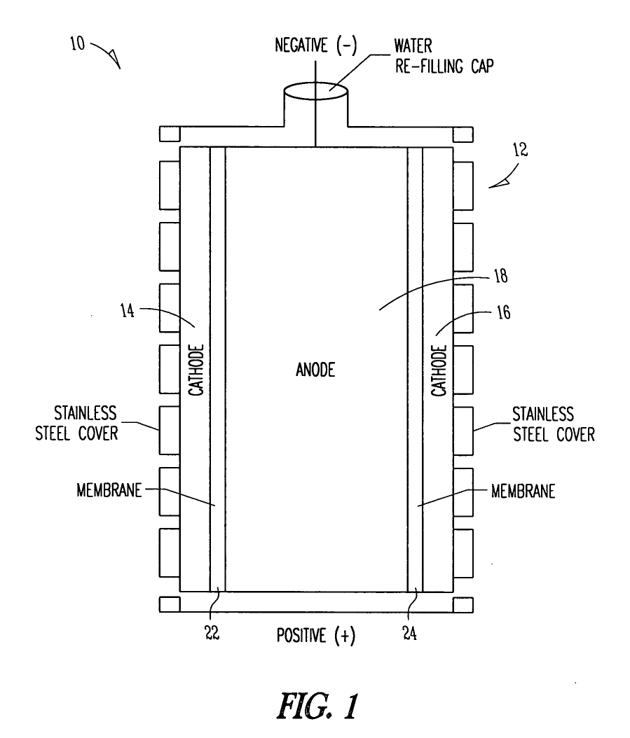

One embodiment of a rechargeable fuel cell that may address both water management and continuous energy output at a battery-compatible size is illustrated in FIG. 1. The rechargeable fuel cell 10 may include a fuel cell assembly 12. The fuel cell assembly 12 may include a first cathodic electrode 14, a second cathodic electrode 16 and an anodic electrode 15.

The anodic electrode 15 has a water/electrolyte storage mechanism effective for cooling the fuel cell assembly 12 without flooding the fuel cell assembly 12. The anodic electrode 15 may be positioned between the first cathodic electrode 14 and the second cathodic electrode 16. For some embodiments, the anodic electrode 15 may have a thickness that is greater than the thickness of an anodic electrode in a rechargeable fuel cell with a single cathodic electrode. In one embodiment, the anodic electrode 15 has a thickness effective and/or sufficient to power a laptop computer at current power draw requirements for at least about 10 hours.

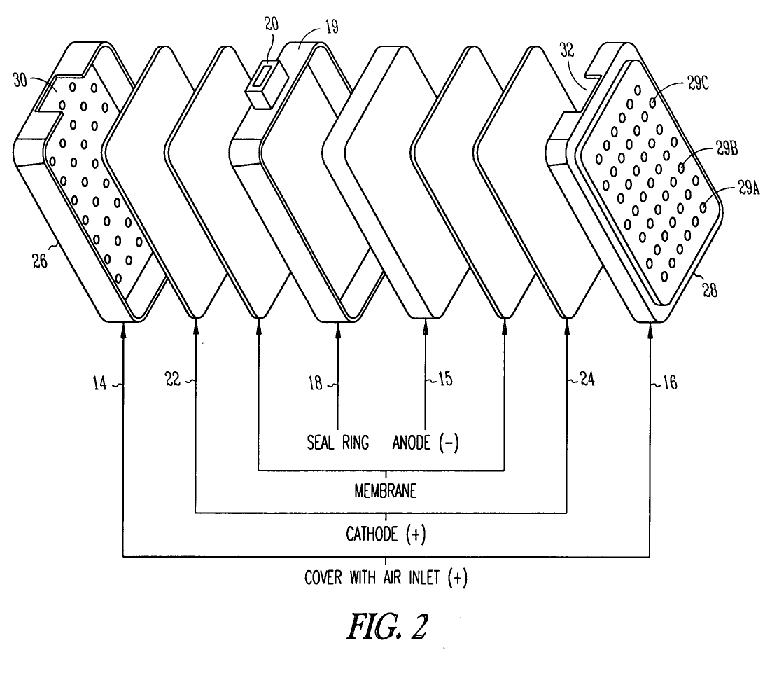

The fuel cell assembly 12 may be sealed with a seal ring 18, illustrated in FIGS. 1 and 2. The seal ring 18 defines an electrolyte/water inlet 19 and may include current collector capability. The seal ring 18 also has a water-filling mechanism 20 that enables the fuel cell to be recharged with water, as is needed to prevent water starvation and excessive heating. The rechargeable fuel cell 10 also may include a water re-filling cap 23, positioned on top of the rechargeable fuel cell 10.

The rechargeable fuel cell 10 further may include two covers 26 and 28 with two air inlets 29A, 29B, and 29C, shown for cover 28, each having a cap, the two cathode electrodes 14 and 16, two membrane separators 22 and 24, respectively, one thick anode 15 and the seal ring 18 with water re-filling mechanism 20 with cap 23 on the top of the rechargeable fuel cell 10. The air inlets 26 and 28 have an inner surface that may define a plurality of apertures or holes. Exemplary apertures are shown at 29A, 29B and 29C, shown for cover 28 for air ingress. For some embodiments, the air inlets 26 and 28 are made of stainless steel or of plastic. Suitable plastics may be thermoformable, or may be thermoset composites.

The rechargeable fuel cell 10 has relatively improved anode efficiency over a fuel cell having one anode and one cathode because hydrogen in the rechargeable fuel cell 10 may diffuse in two or more directions. The efficiency may be equivalent to that of a fuel cell having an anode with a thickness that is one-half that of the thickness of a single anode, single cathode fuel cell. The working current of the rechargeable fuel cell 10 may be doubled and the output power may be doubled because the cathode area is doubled.

The performance of the rechargeable fuel cell 10 may be equivalent to that of two single rechargeable fuel cells connected in parallel. In one embodiment, the rechargeable fuel cell 10 may use only two covers instead of four covers that would be used in two single cells. The rechargeable fuel cell 10 has an improved energy density as compared to a single cell. The rechargeable fuel cell 10 also has an improved package spacing efficiency, when stacked, as compared to a similarly configured battery stack.

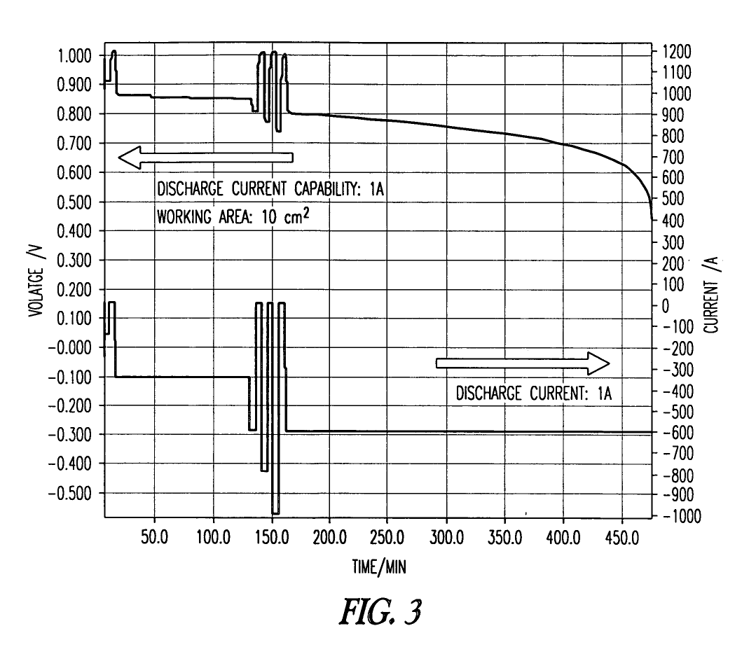

The rechargeable fuel cell embodiment 10 may have a power output that may be about two times the power output of a rechargeable fuel cell having one cathode. A time-power-current profile is shown in FIG. 3 for one single cell rechargeable fuel cell embodiment, having two cathodes, an anode and a water filling mechanism, such as is shown at 10 in FIGS. 1 and 2. FIG. 3 shows that with the double-cathode design, the cell can discharge at even 1 A current. When discharged at 600 mA current, the rechargeable fuel cell has a comparable discharge voltage to that of a single cathode design when discharging at 300 mA current.

The water re-filling mechanism 20 of the rechargeable fuel cell 10 may reduce water management monitoring and control needs within the fuel cell. The water may be added to the inside of the fuel cell through the water re-filling cap to extend the working life of the cells.

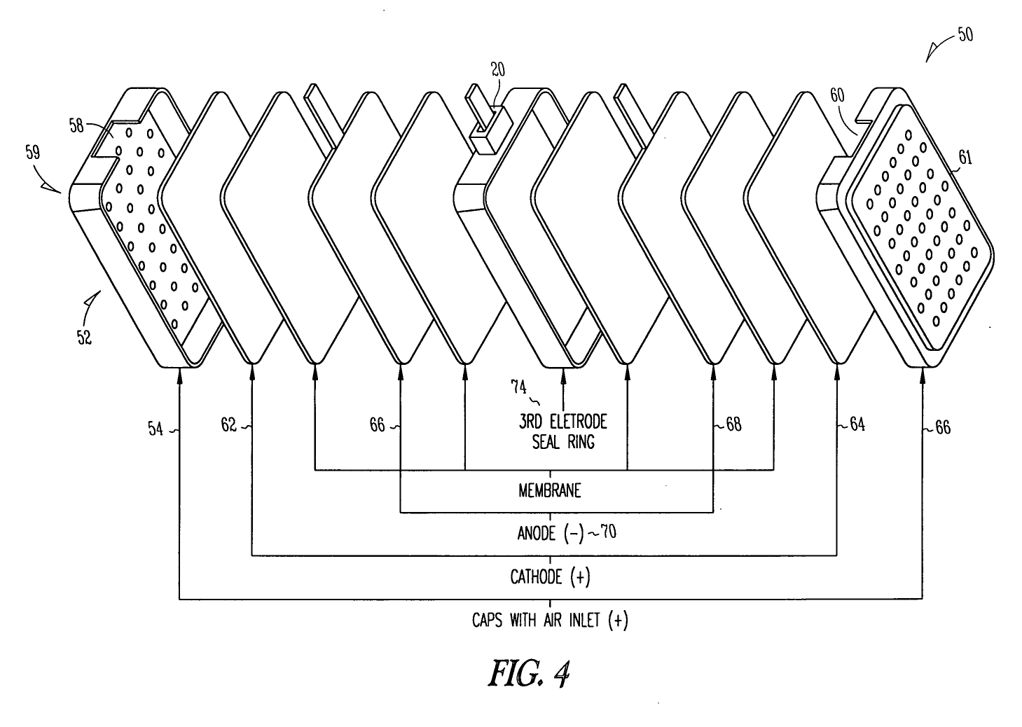

In one embodiment, a cell is provided having water management capability and a third electrode. The cell 50 is shown in an exploded view in FIG. 4. The rechargeable fuel cell 50 may include fuel cell cathodes 62 and 64, anodes 68 and 66, a third electrode 101, and water filling mechanism 100.

The addition of the third electrode 101 may reduce or prevent damage to the electrodes 62 and 64 during an oxygen evolution reaction. The third electrode 101 controls the charging process to take place between the anode electrode 68 and the third electrode 101, while the discharge process takes place between the anode 66 and the cathode 62 electrodes.

The rechargeable fuel cell 50, with double-cathode design and third electrode 101, may include air inlet caps 59 and 61 having apertures that define a plurality of air inlets 58 and 60, respectively. The rechargeable fuel cell also may include two stainless steel caps 54 and 56, for enclosing and removably blocking each of the inlets 58 and 60. The rechargeable fuel cell additionally may include membrane separators 92, 94, 96 and 98, and a seal ring 74.

The rechargeable fuel cell 50 may include fuel cell assembly 52 that may include the cathode 62, membrane 92 and anode 66. The rechargeable fuel cell 50 also may include fuel cell assembly 53 that may include cathode 64, membrane 98 and anode 68. A charging assembly 40 may include anodes 66 and 68, membrane separators 94 and 96 and third electrode 101. By limiting the charge reaction to that taking place between the anode electrode 68 and the third electrode 101, the cycle life of the rechargeable fuel cell 50 is increased.

The third electrode 101 may be made of stainless steel, nickel, or a conductive metal. The metal may be foamed to define connective pores. In one embodiment, the third electrode is nickel foam. Combinations of metals may be used, for example, the third electrode may be made of a combination of stainless steel and nickel foam. Other embodiments of third electrodes may be made of other metals and/or metal foams. The rechargeable fuel cell 50 may define a volume within pores that may be used to accept, retain, and/or absorb water and/or electrolyte, and to serve as a reservoir for storing water and electrolyte.

For some embodiments, the cathode 62, membrane separator 92 and anode 66 may function as a hydrogen-utilizing portion of the rechargeable fuel cell 50. The cathode 64, membrane separator 98 and anode 68 may function as a second hydrogen-utilizing component of the rechargeable fuel cell 50. The third electrode 101, membrane separator 96 and anode 68 may function as a hydrogen-generating component of the rechargeable fuel cell 50. Other combinations of hydrogen-generating components and hydrogen-utilizing components may be used.

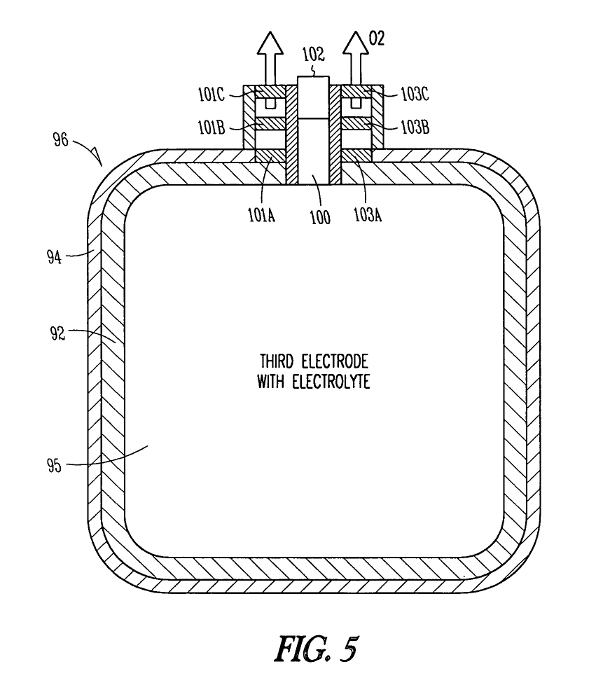

One other rechargeable fuel cell 80 having two cathodic electrodes, an anodic electrode and a third electrode is shown in cross-section in FIG. 5. The rechargeable fuel cell 80 may include a third electrode with electrolyte 85, oxygen and electrolyte 82 and a membrane 86 and a water filling mechanism 102. The rechargeable fuel cell embodiment 80 also may include a seal ring 84 that defines air channels 88 and 89 and a channel 90, shown in FIG. 5, for anodic current collection and for imparting a capability for filling the fuel cell with water or electrolyte. The rechargeable fuel cell embodiment 80 may include a cap 91 operable to enclose the channel 90. Within the channels 88 and 89 may be a plurality of superhydrophobic membranes 71A, 71B, 71C, 73A, 73B and 73C for retaining water and water vapor within the fuel cell 80.

In one embodiment, the working current for rechargeable fuel cell embodiments 10, 50 and 80 may be increased by up to two times that of fuel cells that do not include a second cathode because the cathode working area in these fuel cells is double that of a rechargeable fuel cell having only a single cathode. The anode efficiency may be increased by up to two times that of a rechargeable fuel cell with only a single cathode. The efficiency increase may be because protons inside the anode are diffusible in two or more directions. The spacing efficiency of the fuel cell embodiments may be relatively improved because the distance between the anode and the first cathode and the anode and the second cathode may be equivalent to two parallel single fuel cells. The energy density of the fuel cell embodiments may be increased, in part, because the rechargeable fuel cell may have a capability for being filled with water or electrolyte.

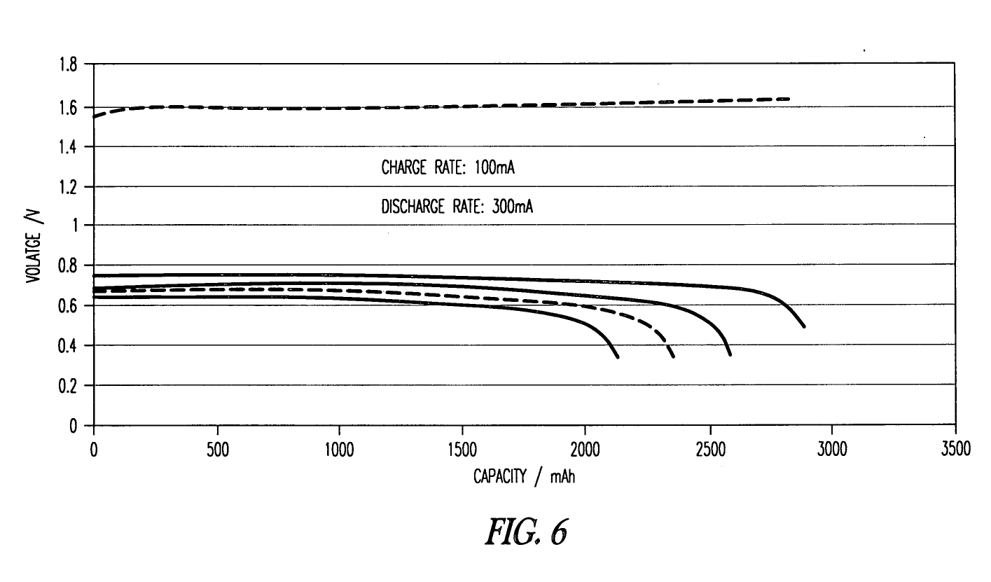

The rechargeable fuel cell embodiments 10, 50, and 80 may have a relatively higher energy and power density than rechargeable fuel cells having a single cathode. The rechargeable fuel cell embodiments 10, 50 and 80 may have an improved space efficiency and may have an improved anode efficiency, compared to fuel cells having a single cathode. This improved anode efficiency offsets any loss of efficiency resulting from increasing the thickness of the anode. Relationships between capacity and voltage for a double-cathode fuel cell, described herein, are shown graphically in FIG. 6.

The rechargeable fuel cell embodiments 10, 50, and 80 may have relatively improved anode efficiency even when anode thickness is increased. Anode efficiency is increased because atomic hydrogen is diffusible in two or more directions over a shorter distance because of the presence of two cathodes that both face the anode.

The water-filling mechanism feature of fuel cell embodiments 10, 50, and 80 may reduce or eliminate one or more issues related to water drying of the membranes and of other components of the fuel cell. Too much water in the fuel cell may flood the electrodes, stopping the reaction. Insufficient water may result in the membrane losing its ability to conduct OH— across the cell.

Operation of the fuel cell at high temperature may be problematic if the temperature is high enough for water in the fuel cell to vaporize. High temperature may cause the membrane to dry and lose conductivity. The fuel cell may need water in the electrolyte as well as water at the anode. Water may be generated at the cathode. The more power a fuel cell makes, the faster the cathode produces water and the warmer the fuel cell becomes. Because the fuel cell embodiments described herein are not necessarily closed containers, the heat generated at the cathode may lead to evaporation of some water from the cell. The problem of heat generation and water loss may be compounded in fuel cell embodiments having two cathodes, as described herein, because more heat may be generated by two cathodes than in a conventional single cathode fuel cell. The fuel cell embodiments 10, 50 and 80 solve the problem of water loss with the water filling mechanism feature, shown at 20 in FIG. 1, 100 in FIG. 4 and 102 in FIG. 5. Water loss may be reduced by the series of membranes 71A-C and 73A-C within the air egress channels 89 and 90, shown in FIG. 5, which prevent or reduce water loss.

The outside temperature and humidity may influence the water management inside the fuel cell. If, under humid conditions, a fuel cell has too much water at the cathode, oxygen can't get to the electrode, and the fuel cell may shut down as a result of flooding. In a dry climate, the heat from fuel cell operation may parch the electrode, starving it of water, and may stop the device from operating.

The electrolyte may be a porous matrix saturated with an aqueous alkaline solution, such as potassium hydroxide (KOH.). Other electrolytes suitable for use in the rechargeable fuel cell may include alkaline hydroxides or salt solutions.

The membrane components 71A-C and 73A-C, for some embodiments are superhydrophobic membranes. “Super-hydrophobicity,” “super-lipophobicity,” “super-amphiphobicity,” and “super-liquid phobicity” all refer to properties of substances which cause a liquid drop on their surface to have a contact angle of 150 degrees or greater. Depending upon context, the liquid drop can include, e.g., a water/water based/aqueous drop (super-hydrophobicity), a lipid based drop (super-lipophobicity), a water based or lipid based drop (super-amphiphobicity), or other liquids. Super-liquid phobicity comprises a generic term indicating a substance that causes a fluid drop (e.g., lipid based, aqueous based, or other) to have a greater than 150 degrees contact angle.

Suitable anode metal hydrides include but are not limited to nickel, Mm, Co, Al, Mn, Mo, Ti, Zn, Rh, Ru, Ir, La, Ni, Fe, Ti, Zr, W, V, B and alloys of these materials. The anode embodiments may include an active material supported on a current collector grid. The active material for the anode may include a hydrogen storage material, Raney Nickel, binder material, and graphite or graphitized carbon. The hydrogen storage material may be selected from Rare-earth metal alloys, Misch metal alloys, zirconium alloys, titanium alloys, magnesium/nickel alloys, and mixtures or alloys thereof which may be AB, AB₂, or AB₅ type alloys. Such alloys may include modifier elements to increase their hydrogen storage capability

Catalysts used in the fuel cell embodiments described herein are made from precursors that include AgNO₃, Co(NO₃)₂, a cobalt amine complex, Ni(NO₃)₂, Mn(NO₃)₂, platinum, palladium, ruthenium cyano complexes, organo metallic complexes, amino complexes, citrate/tartrate/lactate/oxalate complexes, transition metal complexes, transition metal macro-cyclics, and mixtures thereof.

The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal, such as nickel metal foam.

Various materials may be used for the cell frame components, spacers, and other support structures described herein, which are preferably inert to the system chemicals. Such materials include, but not limited to, thermoset, thermoplastic, and rubber materials such as polycarbonate, polypropylene, polyetherimide, polysulfonate, polyethersulfonate, polyarylether ketone, ethylene propylene diene monomer, ethylenepropylene rubber, and mixtures comprising one or more of the foregoing materials.

While double cathode rechargeable fuel cells are described, it is understood that embodiments of the invention may include one or more stacks of double cathode rechargeable fuel cells. It is contemplated that the method and rechargeable fuel cell embodiments described herein are usable to power devices that include but are not limited to cellular phones, PDA's, satellite phones, a laptop computers, portable DVD's, portable CD players, portable personal care electronics, portable boom boxes, portable televisions, radar, radio transmitters, radar detectors, cordless tools and appliances, and combinations thereof.

The foregoing examples are merely illustrative of some of the features of the invention. The appended clauses are intended to define the invention as broadly as it has been conceived and the examples herein presented are illustrative of selected embodiments from a manifold of all possible embodiments. Accordingly it is Applicants' intention that the appended clauses are not to be limited in definition by the choice of examples utilized to illustrate features of the present invention. As used in the clauses, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and, where not already dedicated to the public, those variations should be construed to be covered in the appended clauses. It is also anticipated that advances in science and technology will make equivalents and substitutions possible that are not now contemplated by reason of the imprecision of language and these variations should also be construed where possible to be covered by the appended clauses.

What is claimed is:

1. An electrochemical cell comprising:
a first cathodic electrode and a second cathodic electrode;
an anodic electrode positioned between the first cathodic electrode and the second cathodic electrode;
a first membrane positioned between the first cathodic electrode and the anodic electrode;
a second membrane positioned between the second cathodic electrode and the anodic electrode; and
a water-refilling mechanism in fluid communication with one or both of the first membrane or the second membrane.

2. The electrochemical cell of claim 1, further comprising electrolyte disposed between the anodic electrode and the first cathodic electrode and disposed between the anodic electrode and the second cathodic electrode.

3. The electrochemical cell of claim 1, wherein the water-filling mechanism defines a channel operable to provide fluid to at least one of the cathodic electrodes.

4. The electrochemical cell of claim 3, wherein the channel is configured to allow fluid to flow into the electrochemical cell, and to reduce or prevent fluid from flowing out of the electrochemical cell.

5. The electrochemical cell of claim 1, wherein the water-filling mechanism comprises a seal ring that defines one or more channels for receiving water.

6. The electrochemical cell of claim 5, wherein the seal ring defines one or more channels for air or oxygen egress.

7. The electrochemical cell of claim 6, wherein one or more of the membranes are positioned in the channels for air or oxygen egress to prevent or reduce water vapor loss.

8. A method, comprising:
coupling a first cathode to rechargeable fuel cell comprising an anode, a second cathode, electrolyte and a membrane, such that the anode is disposed between the first and second cathodes; and
coupling one or more mechanisms for water filling and water retention to the fuel cell such that a channel is defined from a peripheral edge to one or more of the cathodes.

9. The method of claim 8, further comprising providing fluid through the channel to the one or more cathodes.

10. A fuel cell seal ring comprising a mechanism for water filling.

11. The fuel cell seal ring of claim 10 wherein the mechanism for water filling comprises a channel defined by the seal ring.

12. The fuel cell ring of claim 10, wherein the seal ring further comprises a mechanism for water retention.

13. The fuel cell ring of claim 10, wherein the mechanism for water retention comprises a cap operable to block the flow of water into and out of the mechanism.

14. The fuel cell seal ring of claim 10, wherein the seal ring defines one or more channels for air or oxygen egress.

15. The fuel cell ring of claim 10, wherein the fuel cell seal ring further comprises one or more membranes capable of preventing or reducing water loss from the fuel cell interior.

16. A fuel cell comprising the fuel cell seal ring of claim 10.

17. A rechargeable fuel cell stack, comprising two or more of the fuel cells of claim 16.

18. A rechargeable fuel cell comprising:
a first cathodic electrode;
a second cathodic electrode spaced from the first cathodic electrode;
a third electrode;
an anodic electrode positioned between the second cathodic electrode and the third electrode;
a membrane positioned between the second cathodic electrode and the anodic electrode;
another membrane positioned between the third cathodic electrode and the anodic electrode; and
a water-refilling mechanism in fluid communication with at least one of the electrodes.

19. The rechargeable fuel cell of claim 18, further comprising a second anode positioned between the first cathodic electrode and the third electrode.

20. The rechargeable fuel cell of claim 18, wherein the water-refilling mechanism is capable of flowing water or electrolyte into the fuel cell interior.

21. The rechargeable fuel cell of claim 20, wherein the water-refilling mechanism comprises means for retaining water and water vapor from gases that would otherwise egress out from the rechargeable fuel cell.

22. The rechargeable fuel cell of claim 18, further comprising one or more membranes positioned within the water-filling mechanism.

23. A device powered by the rechargeable fuel cell of claim 18.
